(19) United States
(12) Patent Application Publication
(10) Pub. No.: US 2011/0273775 A1
(43) Pub. Date: Nov. 10, 2011

(54) DIFFRACTIVE OPTICAL ELEMENT AND OPTICAL DEVICE

(76) Inventors: Junpei SASAKI, Osaka (JP); Makoto KIMURA, Hyogo (JP); Kenji INOUE, Hyogo (JP)

(21) Appl. No.: 13/099,407

(22) Filed: May 3, 2011

(30) Foreign Application Priority Data
May 6, 2010 (JP) 2010-106111
Apr. 26, 2011 (JP) 2011-098458

(51) Int. Cl. G02B 5/18

(52) U.S. Cl. 359/576

(57) ABSTRACT

A diffractive optical element includes a first optical member including a first diffraction grating; and a second optical member including a second diffraction grating and arranged so that the second diffraction grating faces the first diffraction grating. Inorganic particulates are dispersed in the second optical member. An inorganic particulate volume ratio is higher in the second diffraction grating than a portion of the second optical member on an opposite side of the second diffraction grating.

### CROSS-REFERENCE TO RELATED APPLICATION

This application claims priority to Japanese Patent Application No. 2010-106111 filed on May 6, 2010 and Japanese Patent Application No. 2011-098458 filed on Apr. 26, 2011, the disclosure of which including the specification, the drawings, and the claims is hereby incorporated by reference in its entirety.

### BACKGROUND

A technique disclosed herein relates to a diffractive optical element including two optical members facing each other, and to an optical device including the diffractive optical element.

Conventionally, a diffractive optical element including two optical members facing each other, in which a diffraction grating is formed in each of the optical members has been known.

Japanese Patent Publication No. 2008-203821 describes a diffractive optical element in which an optical member made of high-refractive low-dispersion material and an optical member made of low-refractive high-dispersion material are stacked without clearances therebetween. A diffraction grating is formed in each of the optical members. The two optical members are stacked so that the diffraction gratings are in close contact with each other. In such optical members, inorganic particulates are dispersed in resin, thereby adjusting a refractive index and an Abbe number of the resin to a desired value. The inorganic particulates are dispersed in both of the optical members, thereby reducing a thermal stress difference between the two optical members.

### SUMMARY

As in Japanese Patent Publication No. 2008-203821, the optical member in which the inorganic particulates are dispersed has been used for various purposes. However, in a case where the inorganic particulates are dispersed in the resin, there is a possibility that a transmittance of the diffractive optical element itself is reduced depending on kinds of the resin and the inorganic particulate. This is because light scattering is caused when a difference between the refractive index of the resin and a refractive index of the inorganic particulate is large.

The technique disclosed herein has been made in view of the foregoing, and it is an objective of the present disclosure to provide a diffractive optical element having a high transmittance even if the diffractive optical element has a configuration in which inorganic particulates are dispersed.

A diffractive optical element solving the foregoing problem includes a first optical member including a first diffraction grating; and a second optical member including a second diffraction grating and arranged so that the second diffraction grating faces the first diffraction grating. Inorganic particulates are dispersed in the second optical member, and an inorganic particulate volume ratio is higher in the second diffraction grating than a portion of the second optical member on an opposite side of the second diffraction grating.

In addition, an optical device solving the foregoing problem includes an optical imaging system configured to focus light bundles on a predetermined surface. The optical imaging system has the diffractive optical element of claim 1.

According to the foregoing configuration, the diffractive optical element having the high transmittance can be provided even if the diffractive optical element has the configuration in which the inorganic particulates are dispersed.

### BRIEF DESCRIPTION OF THE DRAWINGS

FIG. 1 is a schematic view of a camera to which an interchangeable lens of an embodiment is attached.

FIG. 2 is a schematic cross-sectional view illustrating a diffractive optical element.

FIG. 3 is an enlarged fragmentary cross-sectional view of the diffractive optical element.

FIG. 4(A) is a schematic view illustrating a composite layer, and FIG. 4(B) is a schematic view illustrating a resin layer.

FIGS. 5(A)-5(F) are schematic views illustrating a method for manufacturing the diffractive optical element. FIG. 5(A) illustrates a state in which material which will be the composite layer and a first optical member are set in a mold. FIG. 5(B) illustrates a state in which the composite layer is molded with the first optical member and the mold. FIG. 5(C) illustrates a state in which the first optical member and the composite layer are released from the mold. FIG. 5(D) illustrates a state in which material which will be the resin layer, and the first optical member and the composite layer are set in the mold. FIG. 5(E) illustrates a state in which the resin layer is molded with the first optical member and the composite layer, and the mold. FIG. 5(F) illustrate a state in which the first optical member and a second optical member are released from the mold.

FIG. 6 is a schematic view illustrating a manufacturing method in another embodiment.

FIG. 7 is a schematic view illustrating a manufacturing method in still another embodiment.

### DETAILED DESCRIPTION

An example embodiment will be described below in detail with reference to the drawings.

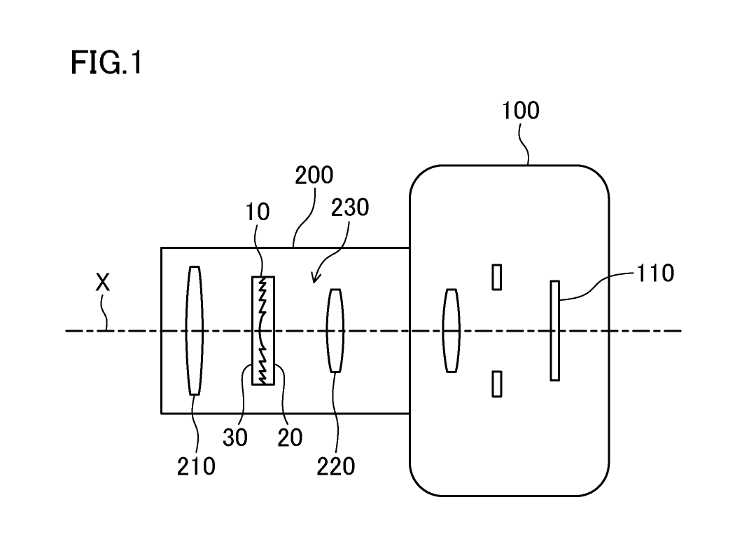

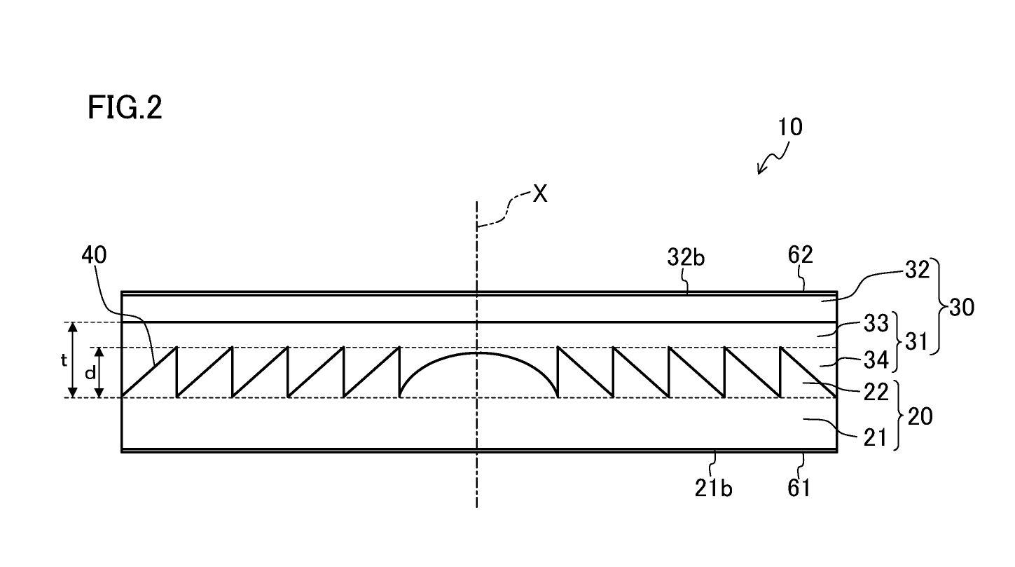

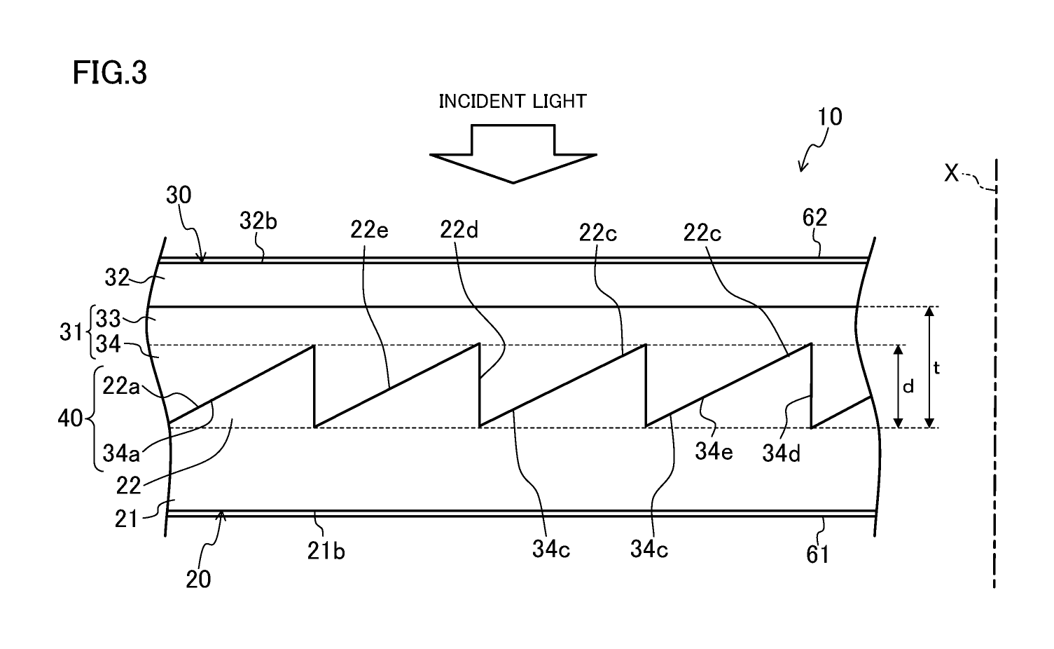

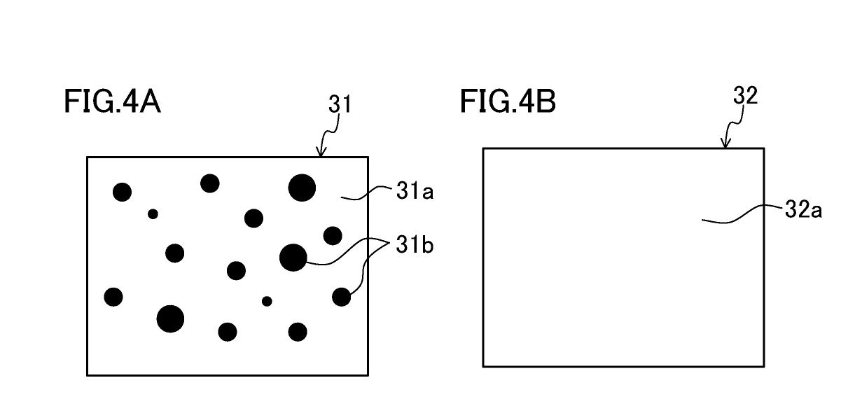

FIG. 1 is a schematic view of an interchangeable lens 200 including a diffractive optical element 10 of the present embodiment, and a camera 100 to which the interchangeable lens 200 is attached. FIG. 2 is a schematic cross-sectional view illustrating the diffractive optical element 10 of the present embodiment. FIG. 3 is an enlarged fragmentary view of the diffractive optical element 10 of the present embodiment. FIG. 4(A) is a schematic view illustrating a composite layer 31, and FIG. 4(B) is a schematic view illustrating a resin layer 32.

The interchangeable lens 200 is detachable from the camera 100. The interchangeable lens 200 is, e.g., a telephoto zoom lens. In the interchangeable lens 200, the diffractive optical element 10 serves as a lens element in addition to refractive lenses 210, 220. The refractive lenses 210, 220 and the diffractive optical element 10 form an optical imaging system 230 configured to focus light bundles on an imaging element 110 of the camera 100. The interchangeable lens 200 or the camera 100 including the interchangeable lens 200 forms an optical device.

As illustrated in FIG. 2, the diffractive optical element 10 is a close-contact type multilayer diffractive optical element in which a first optical member 20 and a second optical member 30 having light transmission properties are stacked.

The first optical member 20 includes a first diffraction grating 22. The second optical member 30 includes a second diffraction grating 34. The first and second optical members 20, 30 are arranged so that the first diffraction grating 22 and the second diffraction grating 34 face each other. The “face” means that two members may be opposite to each other, and includes a state in which the two members are in close contact with each other, a state in which there is a clearance between the two members, and a state in which other member is interposed between the two members. In the present embodiment, the first and second diffraction gratings 22, 34 are bonded together in close contact with each other. A diffraction surface 40 defined by the first and second diffraction gratings 22, 34 is formed at an interface between the first optical member 20 and the second optical member 30. Optical power of the diffraction surface 40 has wavelength dependency. Thus, the diffraction surface 40 provides the substantially same phase difference to light having different wavelengths, and diffracts the light having different wavelengths at diffraction angles which are different from each other. As illustrated in, e.g., FIG. 3, light entering the diffractive optical element 10 from the second optical member 30 side is diffracted at the diffraction surface 40 to exit to the first optical member 20 side.

The first optical member 20 is a discoid member, and the first diffraction grating 22 is formed in one of facing surfaces of the first optical member 20. Specifically, the first optical member 20 includes a flat plate-like first base section 21, and the first diffraction grating 22 integrally formed with the first base section 21. In the present embodiment, the first optical member 20 is made of glass material. The first diffraction grating 22 includes a plurality of ridge-like raised portions 22c which extend in a circumferential direction around an optical axis X of the diffractive optical element 10, and which are concentrically arranged around the optical axis X. Each of the raised portions 22c has a vertical surface 22d which is substantially parallel to the optical axis X (i.e., extends along the optical axis X), and a surface 22e which is inclined to the optical axis X (i.e., inclined to the vertical surface 22d). Each of the raised portions 22c has a substantially triangular cross section. The inclined surface 22e may be curved so as to define an aspherical or spherical surface. A surface 21b of the first base section 21 on an opposite side of the first diffraction grating 22 is formed into a flat surface. Note that the surface 21b of the first base section 21 may be formed so as to define an aspherical or spherical surface.

The second optical member 30 is a discoid member, and the second diffraction grating 34 is formed in one of facing surfaces of the second optical member 30. The second optical member 30 is formed by dispersing inorganic particulates in a medium such as resin etc. Specifically, the second optical member 30 includes the composite layer 31 and the resin layer 32. The composite layer 31 forms a first layer, and the resin layer 32 forms a second layer.

The composite layer 31 is made of composite material in which inorganic particulates are dispersed in resin. The composite layer 31 includes a second base section 33 and the second diffraction grating 34 integrally formed with the second base section 33. The second diffraction grating 34 includes a plurality of valley-like recessed portions 34c which extend in the circumferential direction around the optical axis X of the diffractive optical element 10, and which are concentrically arranged around the optical axis X. Each of the recessed portions 34c has a vertical surface 34d which is substantially parallel to the optical axis X, and a surface 34e which is inclined to the optical axis X. Each of the recessed portions 34c has a substantially triangular cross section. The inclined surface 34e may be curved so as to define an aspherical or spherical surface.

The resin layer 32 is substantially made of resin. The “substantially” means that substances such as inorganic particulates etc. other than resin may be contained in resin as long as such substances do not influence a refractive index of the resin layer 32. The resin layer 32 is stacked on the second base section 33 of the composite layer 31. The resin layer 32 is a plate-like member. Note that the resin layer 32 is not limited to the plate-like member, and may be a membranous member. A surface 32b of the resin layer 32 on an opposite side of the second base section 33 is a flat surface, and is formed parallel to the surface 21b of the first diffraction grating 22. Note that the surface 32b of the resin layer 32 is not necessarily parallel to the surface 21b of the first diffraction grating 22. The surface 32b of the resin layer 32 may be formed so as to define an aspherical or spherical surface. The resin layer 32 corresponds to a portion of the second optical member 30 on an opposite side of the second diffraction grating 34.

The first diffraction grating 22 and the second diffraction grating 34 have the same grating height d and the same grating pitch. That is, the raised portions 22c of the first diffraction grating 22 are exactly fitted into the recessed portions 34c of the second diffraction grating 34. Consequently, a first diffraction surface 22a of the first optical member 20 and a second diffraction surface 34a of the second optical member 30 contact each other without clearances, thereby forming the single diffraction surface 40. Note that an intermediate layer such as air, an antireflection film, an adhesive, etc. which has a refractive index different from those of the first diffraction grating 22 and the second diffraction grating 34 may be interposed between the first diffraction surface 22a and the second diffraction surface 34a.

The surface 21b of the first base section 21 of the first optical member 20 is covered with an antireflection film 61. The surface 32b of the resin layer 32 of the second optical member 30 is covered with an antireflection film 62. The antireflection films 61, 62 are made of silicon oxide, titanium oxide, aluminum oxide, zirconia oxide, tantalum oxide, magnesium oxide, or alloy oxide of, e.g., silicon, titanium, aluminum, etc. For example, the antireflection films 61, 62 are made of SiO₂ and TiO₂. The antireflection films 61, 62 may be formed by stacking such materials into a single layer or stacking such materials into multiple layers. The thickness of the antireflection films 61, 62 is, e.g., about 200-400 nm. Note that the antireflection films 61, 62 may be made of the same material, or may be made of different materials.

The composite layer 31 and the resin layer 32 will be described in more detail.

As illustrated in FIG. 4(A), the composite layer 31 contains first resin 31a as base material, and inorganic particulates 31b are dispersed in the first resin 31a. Material in which the inorganic particulates 31b are dispersed in the first resin 31a may be simply referred to as “composite material.”

As illustrated in FIG. 4(B), the resin layer 32 is substantially made of second resin 32a. In the present embodiment, the resin layer 32 is only made of the second resin 32a. Since the inorganic particulates are not contained in the resin layer 32, a transmittance of the resin layer 32 is higher than that of the composite layer 31. Note that the resin layer 32 may contain the inorganic particulates within a range which does not influence the refractive index of the resin layer 32. However, in order to improve a transmittance, it is preferable that the inorganic particulates are not contained in the resin layer 32.

As illustrated in FIGS. 2 and 3, the composite material fills each recessed portion between the raised portions 22c of the first diffraction grating 22, and therefore a thickness t of the composite layer 31 is determined by the grating height d of the second diffraction grating 34 and the thickness (dimension in an optical axis direction) of the second base section 33. Since the composite layer 31 contains the inorganic particulates, an extreme increase in thickness of the composite layer 31 causes reduction of a transmittance of the second optical member 30. Considering the foregoing point, the thickness t of the composite layer 31 is preferably equal to or less than about 50 μm, and more preferably equal to or less than about 30 μm.

The first resin 31a and the second resin 32a are, e.g., acrylic resin, epoxy resin, vinyl resin, etc. In addition, the first resin 31a and the second resin 32a are energy curable resin such as ultraviolet curable resin, thermoset resin, etc. The first resin 31a and the second resin 32a may be the same material, or may be materials different from each other.

It is desirable that the inorganic particulate 31b has an average particle diameter of equal to or greater than about 1 nm and equal to or less than about 50 nm. By setting the average particle diameter to equal to or greater than about 1 nm, a state can be stably maintained, in which the inorganic particulates 31b are dispersed in the first resin 31a. In addition, by setting the average particle diameter to equal to or less than about 50 nm, light scattering can be reduced in the composite layer 31.

The inorganic particulate 31b may be formed in a spherical or aspherical shape. Alternatively, the inorganic particulate 31b may be formed in an irregular shape. Surface treatment such as coating, dispersant application, etc. for enhancing dispersibility may be applied to a surface of the inorganic particulate 31b.

Material of the inorganic particulate 31b is, e.g., titanium oxide (TiO₂), zinc oxide (ZnO), zirconium oxide (ZrO₂), silicon dioxide (SiO₂), aluminum oxide (Al₂O₃), indium oxide (In₂O₃), barium titanate (BaTiO₃), etc. The inorganic particulate 31b may be made of material which can realize optical functions required for the second optical member 30.

Manufacturing Method

Next, a method for manufacturing the diffractive optical element 10 will be described.

First, a mold (not shown in the figure) is prepared, in which an inverted shape of a first diffraction grating 22 is formed. The mold is filled with softened glass material. Then, a first optical member 20 is molded.

Next, composite material 50 is produced. In the present embodiment, acrylic ultraviolet curable resin is used as first resin 31a, and zinc oxide is used as an inorganic particulate 31b. For example, a fluid dispersion is first produced, which contains ketone of about 77% by mass as a dispersion medium, zinc oxide of about 20% by mass with an average particle diameter of about 8 nm, and an amine dispersant of about 3% by mass. Acrylic ultraviolet curable resin and the fluid dispersion are mixed at a ratio at which the acrylic ultraviolet curable resin is about 44% by mass and the dispersion is about 56% by mass. The mixing is performed by using a hot stirrer at a temperature of about 50° C. and a rotational speed of about 200 rpm for a mixing time of about 30 minutes. Subsequently, such a material mixture is desolvated by an evaporator. The desolvation is performed is performed under conditions under which a temperature of a flask filled with the material mixture and a water bath in which the flask is dipped is about 45° C., and a desolvation time is about 30 minutes. In such a manner, the composite material 50 is produced.

Primer treatment is applied in order to increase adhesion between the first optical member 20 made of inorganic material and the composite material 50 substantially made of organic material. As preparation for the primer treatment, a solution of a commercially-available silane coupling agent, which is diluted with ethanol and pure water by about 0.2 vol. % is produced. The first diffraction grating 22 is uniformly coated with such a solution by a dipping method. Subsequently, the solution is dried at, e.g., a temperature of about 110° C. for about 20 minutes, and then the primer treatment is completed.

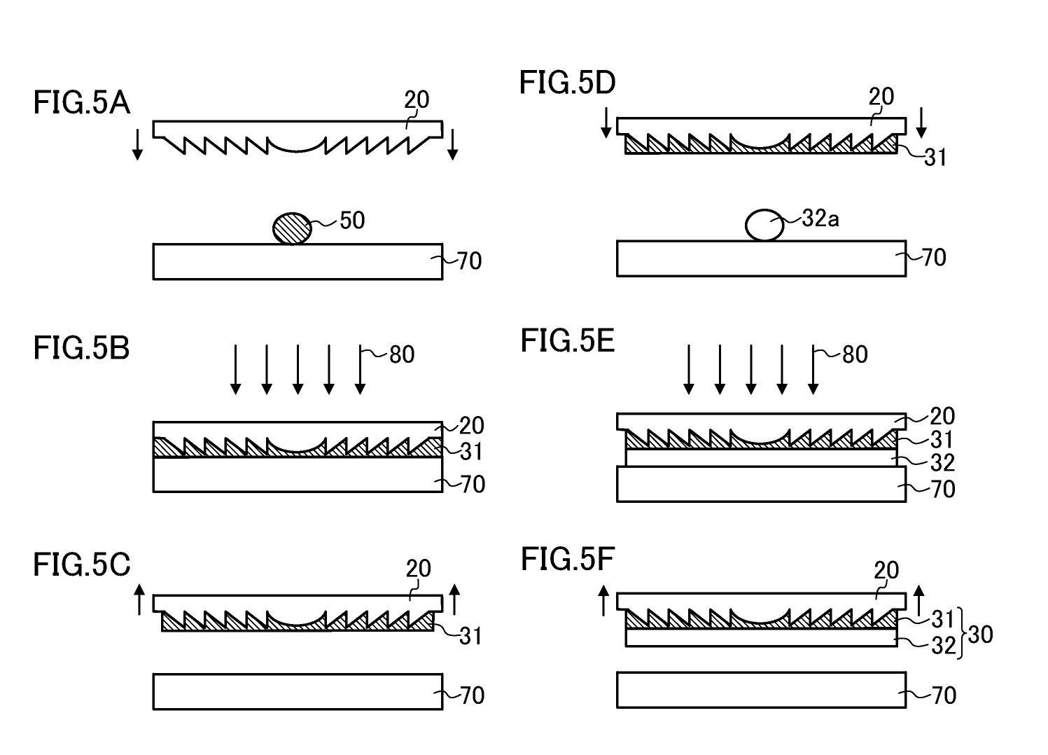

Next, as illustrated in FIG. 5(A), the first optical member 20 is set in a position facing a mold 70 with the first optical member 20 being spaced from the mold 70. In such a state, the first diffraction grating 22 faces the mold 70. The composite material 50 is applied on a molding surface of the mold 70 by using a dispenser. Subsequently, the first optical member 20 is moved to a predetermined position toward the mold 70. In the present embodiment, the position of the first optical member 20 is adjusted so that the thickness of the composite material 50 is about 30 μm. In such a manner, the composite material 50 is stacked on the first diffraction grating 22 of the first optical member 20. In such a state, the composite material 50 flows into each recessed portion between raised portions 22c of the first diffraction grating 22, and then a second diffraction grating 34 contacting the first diffraction grating 22 is formed. Then, as illustrated in FIG. 5(B), a composite layer 31 is formed by irradiating the composite material 50 with ultraviolet 80. The thickness of the composite layer 31 is about 30 μm. Subsequently, as illustrated in FIG. 5(C), the first optical member 20 and the composite layer 31 are released from the mold 70.

Then, as illustrated in FIG. 5(D), the dispenser is used to apply second resin 32a on the molding surface of the mold 70. In the present embodiment, acrylic ultraviolet curable resin is used as the second resin 32a. Then, the first optical member 20 is moved to a predetermined position toward the mold 70. In the present embodiment, the position of the first optical member 20 is adjusted so that the thickness of the second resin 32a is about 170 μm. In such a manner, the second resin 32a is stacked on the composite layer 31. Then, as illustrated in FIG. 5(E), a resin layer 32 is formed by irradiating the second resin 32a with the ultraviolet 80. Consequently, a second optical member 30 having the composite layer 31 and the resin layer 32 is formed. The thickness of the resin layer 32 is about 170 μm. Then, as illustrated in FIG. 5(F), the first optical member 20 and the second optical member 30 are released from the mold 70.

Subsequently, antireflection films 61, 62 are stacked on the surface 21b of the first optical member 20 and the surface 32b of the resin layer 32 by a vacuum deposition method or a wet processing method.

In such a manner, a diffractive optical element 10 is manufactured.

Note that the foregoing manufacturing method is one example, and any manufacturing methods can be applied as long as the diffractive optical element 10 can be manufactured.

According to the present embodiment, the composite layer 31 of the second optical member 30 is made of the composite material in which the inorganic particulates 31b are dispersed in the first resin 31a. Thus, a change in refractive index of the composite layer 31 due to a change in temperature can be reduced as compared to a case where the composite layer 31 is only made of the first resin 31a. The second diffraction grating 34 is formed in the composite layer 31, and a refractive index of the second diffraction grating 34 influences diffraction efficiency at the diffraction surface 40. That is, the second diffraction grating 34 made of the composite material in which the inorganic particulates 31b are dispersed in the resin can reduce the change in refractive index due to the change in temperature, and therefore can reduce a change in diffraction efficiency of the diffractive optical element 10 due to the change in temperature. On the other hand, since the inorganic particulates 31b are not dispersed in the resin layer 32 having less influence on the diffraction efficiency as compared to the second diffraction grating 34, the transmittance can be improved. That is, the transmittance of the second optical member 30 can be improved as compared to a configuration in which the inorganic particulates 31b are dispersed across the entire second optical member 30. Thus, the composite layer 31 and the resin layer 32 can realize optical properties required for the second optical member 30. Specifically, stability of the refractive index is improved in the composite layer 31, and the transmittance is improved in the resin layer 32. Consequently, the diffraction efficiency can be stabilized and the transmittance can be improved across the entire diffractive optical element 10.

Note that the purpose of dispersing the inorganic particulates 31b in the first resin 31a is not limited to the reduction of the change in refractive index of the composite layer 31 due to the change in temperature. In order to adjust the refractive index of the composite layer 31, the inorganic particulates 31b may be dispersed in the first resin 31a. Even in such a case, a refractive index of the composite layer 31 (in particular, a refractive index of a portion of the second diffraction grating 34) can be adjusted to a desired value, and the transmittance of the second optical member 30 can be higher than that of a member only made of the composite material. Thus, the composite layer 31 and the resin layer 32 can realize optical performance required for the second optical member 30. Specifically, the diffraction efficiency can be adjusted (normally, the diffraction efficiency can be improved) and the transmittance can be improved across the entire diffractive optical element 10.

The resin layer 32 is provided, and therefore the thickness of the second optical member 30 can be ensured. That is, it is assumed that, in order to improve the transmittance of the second optical member 30, only a portion for which the inorganic particulates 31b are required, i.e., only the composite layer 31 forms the second optical member 30. Further, it is assumed that only the second diffraction grating 34 in which the inorganic particulates 31b are dispersed forms the second optical member 30. This is because the transmittance is improved by reducing the portion in which the inorganic particulates 31b are dispersed as much as possible. However, if the second optical member 30 includes only the second diffraction grating 34 or the composite layer 31, it is difficult that a surface on an opposite side of the second diffraction surface 34a is formed so as to define a spherical or aspherical surface. That is, in order to form the surface so as to define the spherical or aspherical surface, thick portions are partially required corresponding to the spherical or aspherical shape in the second optical member 30. However, if the second optical member 30 is too thin, a thickness cannot be ensured, with which the spherical or aspherical surface can be formed. Thus, the resin layer 32 is stacked on the composite layer 31, thereby ensuring the thickness of the second optical member 30. This allows the surface 32b of the second optical member 30 on the opposite side of the second diffraction grating 34 to define the spherical or aspherical surface.

In addition to the foregoing, thick portions and thin portions are mixed in the composite layer 31 due to a presence of the second diffraction grating 34. For such a reason, an amount of contraction of the composite layer 31 in a thickness direction of the composite layer 31 due to curing and contraction of the composite layer 31 upon molding varies with portions of the composite layer 31, and therefore there is a possibility that a recessed-raised shape corresponding to the recessed portions 34c is appeared on a surface of the composite layer 31 on the opposite side of the second diffraction grating 34. Therefore, the resin layer 32 is stacked on the composite layer 31, thereby reducing deformation of the surface on the opposite side of the second diffraction grating 34.

Further, since the second optical member 30 has a layer stacking structure of the composite layer 31 and the resin layer 32, material of each of the composite layer 31 and the resin layer 32 can be selected to correspond to performance required for each of the composite layer 31 and the resin layer 32. That is, as the material of the composite layer 31, resin which can realize desired diffraction efficiency is preferably selected considering a relationship with the first optical member 20 and a relationship with the inorganic particulates 31b. As a result of the selection of the material of the composite layer 31 considering the foregoing point, there is a possibility that resin having strength or weather resistance which is not so high is selected. In such a case, as the material of the resin layer 32, resin having high strength or high weather resistance is preferably selected. As in the foregoing case, the material of the composite layer 31 can be selected in quest of the diffraction efficiency, and the material of the resin layer 32 can be selected in quest of reliability. In addition, as a result of the selection of the material of the composite layer 31 considering the foregoing point, there is a possibility that resin having low adhesion to the antireflection film 62 is selected. In such a case, as the material of the resin layer 32, resin having high adhesion to the antireflection film 62 is preferably selected. By providing another layer in addition to the composite layer 31, the strength or the weather resistance can be improved, or the adhesion to the antireflection film 62 can be improved.

The average particle diameter of the inorganic particulates is equal to or greater than about 1 nm and equal to or less than about 50 nm. This maintains the moldability, and reduces the light scattering.

### Other Embodiments

The foregoing embodiment may have the following configurations.

The second optical member 30 has the layer structure in which the composite layer 31 and the resin layer 32 are clearly recognized, but the present disclosure is not limited to such a configuration. That is, the second optical member 30 may be formed by dispersing the inorganic particulates 31b in the resin so that an inorganic particulate volume ratio varies with portions of the second optical member 30. Specifically, the volume ratio of the inorganic particulates 31b to the second optical member 30 may be higher in the second diffraction grating 34 than a portion of the second optical member 30 on an opposite side of the second diffraction grating 34 (a portion near the surface 32b). Alternatively, the volume ratio of the inorganic particulates 31b to the second optical member 30 may be higher in the second diffraction grating 34 than other portions of the second optical member 30. In the entire diffractive optical element 10, this stabilizes the diffraction efficiency or adjusts the diffraction efficiency to a desired level, and improves the transmittance.

The diffractive optical element 10 in which the volume ratio of the inorganic particulates to the second diffraction grating 34 is partially increased can be manufactured as follows. For example, composite material 50, a viscosity of which is increased, is applied on a first diffraction surface 22a of a molded first optical member 20. Then, before the composite material 50 cures, resin material only made of resin which is base material of the composite material 50 is stacked on the composite material 50. Subsequently, the composite material 50 and the resin material are molded, irradiated with ultraviolet 80, and cure, thereby forming a second optical member 30. Since the base material of the composite material 50 and the resin material applied after the application of the composite material 50 are the same material, the second optical member 30 does not have a layer structure. However, inorganic particulates are dispersed only in a portion corresponding to the composite material 50 which is first applied.

Alternatively, a first optical member 20 is arranged so that a first diffraction grating 22 faces up, and low-viscosity composite material 50 in which inorganic particulates 31b are dispersed is applied on a first diffraction surface 22a. Then, the composite material 50 is molded over a relatively-long period of time. While molding the composite material 50, the inorganic particulates in the composite material 50 flow down toward the first diffraction surface 22a. As a result, the inorganic particulate volume ratio is higher in a second diffraction grating 34 than a portion of the second optical member 30 on an opposite side of the second diffraction grating 34. Since the particles of high-viscosity composite material 50 are less likely to flow down in the foregoing method, the inorganic particulate volume ratio of the second diffraction grating 34 may be increased by adding centrifugal force by, e.g., a centrifuge etc.

The inorganic particulate volume ratio can be obtained based on an inorganic particulate area ratio in a cross section of the second optical member 30. Note that not only the inorganic particulate volume ratio but also an inorganic particulate weight concentration or the number of inorganic particulates may be higher in the second diffraction grating 34 than the portion of the second optical member 30 on the opposite side of the second diffraction grating 34.

The first optical member 20 is made of glass, but the present disclosure is not limited to such a configuration. The first optical member 20 may be made of, e.g., resin.

The inorganic particulates are not contained in the resin layer 32, but the present disclosure is not limited to such a configuration. The resin layer 32 may contain the inorganic particulates as long as the resin layer 32 has the transmittance higher than that of the composite layer 31 and can realize the desired optical properties. For example, the resin layer 32 may have the inorganic particulate volume ratio less than that of the composite layer 31.

The layer stacked on the composite layer 31 in the second optical member 30 is the resin layer 32, but the present disclosure is not limited to such a configuration. That is, a layer made of glass may be stacked on the composite layer 31, thereby forming the second optical member 30. In such a case, the glass layer forms the first layer, and the composite layer 31 forms the second layer.

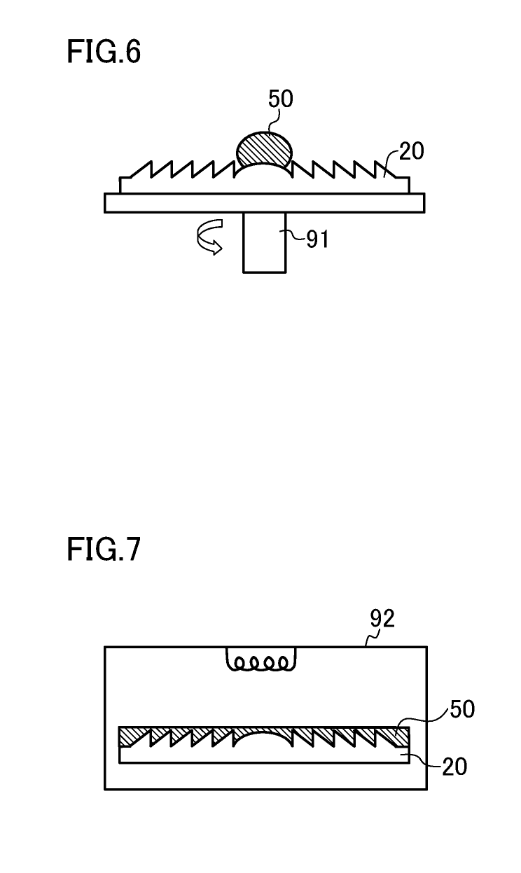

In the foregoing embodiment, the first optical member 20 and the composite material 50 are stacked by sandwiching the composite material 50 between the first optical member 20 and the mold 70, but the present disclosure is not limited to such a configuration. As illustrated in, e.g., FIG. 6, the composite material 50 may be stacked on the first optical member 20 by rotating a spin coater 91.

In the foregoing embodiment, the ultraviolet curable resin is used as the first resin 31a and the second resin 32a, but the present disclosure is not limited to such a configuration. For example, thermoset resin may be used. In such a case, as illustrated in FIG. 7, the composite material 50 and the first optical member 20 may be arranged inside a heat-drying oven 92, and thermal treatment may be applied at, e.g., about 80° C. for about 15 minutes.

In the foregoing embodiment, the composite material 50 and the second resin 32a are irradiated with the ultraviolet 80 from the first optical member 20 side, but the present disclosure is not limited to such a configuration. For example, the composite material 50 and the second resin 32a may be irradiated with ultraviolet from the mold 70 side. In such a case, material of the mold 70 may be transparent glass.

As described above, the technique disclosed herein is useful for the diffractive optical element including the two optical members facing each other, and the optical device including the diffractive optical element.

The description of the embodiments of the present disclosure is given above for the understanding of the present disclosure. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

What is claimed is:

1. A diffractive optical element, comprising:
a first optical member including a first diffraction grating; and
a second optical member including a second diffraction grating and arranged so that the second diffraction grating faces the first diffraction grating,
wherein inorganic particulates are dispersed in the second optical member, and
an inorganic particulate volume ratio is higher in the second diffraction grating than a portion of the second optical member on an opposite side of the second diffraction grating.

2. The diffractive optical element of claim 1, wherein
the second optical member includes a first layer in which the inorganic particulates are dispersed, and the second diffraction grating is formed, and a second layer stacked on the first layer, and
the second layer does not contain the inorganic particulates, or has the inorganic particulate volume ratio lower than that of the first layer.

3. The diffractive optical element of claim 2, wherein
the second layer is made of resin.

4. The diffractive optical element of claim 2, wherein
the second layer is made of glass.

5. The diffractive optical element of claim 1, wherein
an antireflection film is stacked on the second layer on an opposite side of the first layer.

6. An optical device, comprising:
an optical imaging system configured to focus light bundles on a predetermined surface,
wherein the optical imaging system has the diffractive optical element of claim 1.
